(19) United States
(12) Patent Application Publication
(10) Pub. No.: US 2025/0342168 A1
(43) Pub. Date: Nov. 6, 2025

(54) SYSTEMS AND METHODS FOR DATA STRUCTURE ANALYSIS

(71) Applicant: Gestalt Tech Corp., Frisco, TX (US)

(72) Inventors: Obaid Masih, Frisco, TX (US); Kevin Navarre, Kennedale, TX (US); Justin McClintick, Flower Mound, TX (US); Rohit Srivastava, Flower Mound, TX (US); Jackson Van Norman, Austin, TX (US); Jon Christian Lehman, North Richland Hills, TX (US); Brett Norton, Frisco, TX (US)

(21) Appl. No.: 19/197,571

(22) Filed: May 2, 2025

Related U.S. Application Data
(60) Provisional application No. 63/641,495, filed on May 2, 2024.

(51) Int. Cl. G06F 16/25; G06F 16/21

(52) U.S. Cl. CPC G06F 16/258; G06F 16/211

(57) ABSTRACT

A system for converting a source data feed schema into a canonical data product including a memory for storing computer-executable instructions and a processor for executing the instructions stored on the memory. Execution of the instructions programs the processor to perform operations that include receiving a source data feed having a source schema, identifying a plurality of data fields of the source schema, assigning a data category from a plurality of predefined data categories to each data field of the plurality of data fields, modifying the source schema based on predefined parameters, wherein the source schema is modified to match a target schema, comparing the modified source schema to the target schema, and in response to a determination that the modified source schema matches the target schema, converting the source data feed to a canonical data product having the target schema based on the assigned data categories.

### CROSS-REFERENCE TO RELATED APPLICATIONS

This application claims priority to U.S. Provisional Application No. 63/641,495, titled “SYSTEMS AND METHODS FOR DATA STRUCTURE ANALYSIS” and filed on May 2, 2024, the entire disclosure of which is hereby incorporated by reference herein.

### TECHNICAL FIELD OF THE INVENTION

The present disclosure relates to mapping and analyzing data structures and, in particular, converting unique customer data schemas into uniform data schemas.

### BACKGROUND

Lenders often use Structured Query Language (SQL) databases to track loan balances, payment schedules, interest rates, and other details related to active loans. They may generate statements, manage escrow accounts, process payments, and handle borrower communications efficiently using SQL database systems. In addition, lenders are often subject to strict compliance and data reporting requirements. SQL databases may be used to store audit trails, transaction logs, and other compliance-related data to ensure transparency and accountability in lending operations. SQL queries can be used to generate regulatory reports, monitor compliance metrics, and respond to regulatory inquiries or audits.

It can be challenging for lenders to manage the variety of data sources that are fed into their SQL databases. For example, lenders may pull or otherwise receive input databases having their own unique schemas. Such schemas may be configured based on the preferences of the data provider (e.g., customer, loan origination system, etc.). However, these unique schemas are often incompatible with the lender's own schemas. As such, lenders are tasked with reorganizing the input databases to fit their own database schema. This data reorganization process is a tedious, manual process that is prone to introduce errors. In addition, given the high frequency of information requests from investors and regulators, this process has become a constant and expensive task for lenders.

### SUMMARY OF THE INVENTION

In various examples, the subject matter of this disclosure relates to mapping and analyzing data structures and, in particular, converting unique customer data schemas into uniform data schemas.

At least one aspect of the present disclosure is directed to a system for converting a source data feed into a canonical data product. The system includes at least one memory for storing computer-executable instructions and at least one processor for executing the instructions stored on the at least one memory. Execution of the instructions programs the at least one processor to perform operations that include receiving a source data feed having a source schema, identifying a plurality of data fields of the source schema, assigning a data category from a plurality of predefined data categories to each data field of the plurality of data fields, modifying the source schema based on predefined parameters, wherein the source schema is modified to match a target schema, comparing the modified source schema to the target schema, and in response to a determination that the modified source schema matches the target schema, converting the source data feed to a canonical data product having the target schema based on the assigned data categories.

In some embodiments, the source schema is associated with at least one financial institution. In some embodiments, the canonical data product is a financial canonical data product. In some embodiments, execution of the instructions programs the at least one processor to perform operations that include determining, for each data field of the plurality of data fields, a confidence level associated with the assigned data category. In some embodiments, the confidence level is represented as a percentage. In some embodiments, identifying the plurality of data fields of the source schema includes identifying a data type of each data field of the plurality of data fields. In some embodiments, execution of the instructions programs the at least one processor to perform operations that include applying a plurality of data patterns to each data field of the plurality of data fields to identify the data type. In some embodiments, each data pattern of the plurality of data patterns corresponds to at least one regular expression.

In some embodiments, modifying the source schema based on predefined parameters includes modifying a name of a data field, modifying a data type of a data field, consolidating multiple data fields, or any combination thereof. In some embodiments, modifying the name of the data field includes replacing at least one term in the name with at least one term from a predefined list of terms. In some embodiments, execution of the instructions programs the at least one processor to perform operations that further include evaluating, via a matching function, a match level between the modified source schema and the target schema. In some embodiments, execution of the instructions programs the at least one processor to perform operations that include comparing the match level to a minimum accuracy threshold and in response to a determination that the match level meets or exceeds the minimum accuracy threshold, converting the source data feed to the canonical data product.

Another aspect of the present disclosure is directed to a method for converting a source data feed into a canonical data product. The method includes receiving a source data feed having a source schema, identifying a plurality of data fields of the source schema, assigning a data category from a plurality of predefined data categories to each data field of the plurality of data fields, modifying the source schema based on predefined parameters, wherein the source schema is modified to match a target database schema, comparing the modified source schema to the target schema, and in response to a determination that the modified source schema matches the target schema, converting the source data feed to a canonical data product having the target schema based on the assigned data categories.

In some embodiments, the source schema is associated with at least one financial institution. In some embodiments, the canonical data product is a financial canonical data product. In some embodiments, the method includes determining, for each data field of the plurality of data fields, a confidence level associated with the assigned data category. In some embodiments, the confidence level is represented as a percentage. In some embodiments, identifying the plurality of data fields of the source schema includes identifying a data type of each data field of the plurality of data fields. In some embodiments, the method includes applying a plurality of data patterns to each data field of the plurality of data fields to identify the data type. In some embodiments, each data pattern of the plurality of data patterns corresponds to at least one regular expression.

In some embodiments, modifying the source schema based on predefined parameters includes modifying a name of a data field, modifying a data type of a data field, consolidating multiple data fields, or any combination thereof. In some embodiments, modifying the name of the data field includes replacing at least one term in the name with at least one term from a predefined list of terms. In some embodiments, the method includes evaluating, via a matching function, a match level between the modified source schema and the target schema. In some embodiments, the method includes comparing the match level to a minimum accuracy threshold and in response to a determination that the match level meets or exceeds the minimum accuracy threshold, converting the source data feed to the canonical data product.

Another aspect of the present disclosure is directed to a system for detecting anomalies in loan databases. The system includes at least one memory for storing computer-executable instructions and at least one processor for executing the instructions stored on the at least one memory. Execution of the instructions programs the at least one processor to perform operations that include receiving lender information corresponding to a lender, the lender information including historical loan databases associated with the lender, training an anomaly detection algorithm based on the lender information, providing a loan database to the trained anomaly detection algorithm, the loan database including a plurality of data points arranged in a series of columns and a series of rows, and identifying each row of the series of rows that includes an anomaly.

In some embodiments, identifying each row of the series of rows that includes an anomaly includes: conditioning the plurality of data points based on predetermined criteria, assigning a score to each data point of the plurality of data points, calculating an aggregate score for each row of the series of rows, comparing each aggregate score to an anomaly threshold, and identifying each row having an aggregate score that exceeds the anomaly threshold. In some embodiments, assigning a score to each data point of the plurality of data points includes recursively splitting each column of the series of columns to isolate each data point in the column, wherein the score represents an average path length used to isolate the data point. In some embodiments, the columns are split based on different percentile groups that each data point falls in.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 illustrates a block diagram of a smart mapper system 100 in accordance with aspects described herein;

FIG. 2A illustrates an example view of a mapper graphical user interface (GUI) in accordance with aspects described herein;

FIG. 2B illustrates an example view of a mapper GUI in accordance with aspects described herein;

FIG. 2C illustrates an example view of a mapper GUI in accordance with aspects described herein;

FIG. 2D illustrates an example view of a mapper GUI in accordance with aspects described herein;

FIG. 2E illustrates an example view of a mapper GUI in accordance with aspects described herein;

FIG. 2F illustrates an example view of a mapper GUI in accordance with aspects described herein;

FIG. 3 illustrates a flow diagram of a method for dynamically identifying and categorizing data field types within a data frame in accordance with aspects described herein;

FIG. 4 is a flow diagram of a method for converting a source schema into a target schema in accordance with aspects description herein;

FIG. 5 illustrates examples of canonical data products in accordance with aspects described herein;

FIG. 6 is a flow diagram of a method for matching a source schema to a target schema in accordance with aspects described herein;

FIG. 7 illustrates an anomaly detection system in accordance with aspects described herein;

FIG. 8 illustrates an example of partitioning columns of a data table in accordance with aspects described herein;

FIG. 9 illustrates an example bell curve used to determine which rows of a data table are anomalies in accordance with aspects described herein; and

FIG. 10 illustrates an example computer system.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

Disclosed herein are exemplary embodiments of systems and methods for mapping and analyzing data structures. In particular, described are various embodiments of a system that converts unique customer data schemas into uniform data schemas. In some embodiments, a system is provided that scans data structures to identify data anomalies.

### Smart Mapper

SQL databases are a cornerstone of modern data management systems, offering a structured and efficient way to store and manipulate data. SQL databases organize data into tables comprising rows and columns, each representing specific pieces of information. A defined schema serves as a blueprint for designing, implementing, and maintaining a database system, ensuring data consistency, integrity, and efficiency. It provides a structured framework for organizing and managing data to meet the requirements of an application or business process. Interacting with SQL databases involves using the SQL language, which provides commands for querying and modifying data (e.g., DML) as well as defining and altering the database schema (e.g., DDL). Indexing enhances query performance by facilitating rapid data retrieval based on specified criteria. Concurrency control mechanisms ensure that multiple users or applications can access and modify data concurrently without compromising consistency. SQL databases, such as MySQL, PostgreSQL, and Microsoft SQL Server, are widely adopted across various industries for their flexibility, scalability, and reliability in managing structured data.

The database schema refers to a blueprint or structural representation of how data is organized within the database system. It defines the logical structure of the database, including tables, fields, relationships, constraints, and other attributes. A table is a collection of related data organized in rows and columns. Each table in a database represents a specific entity, such as customers, orders, products, etc. Tables are defined with a name and consist of one or more columns. Columns, also known as fields or attributes, represent the individual pieces of data stored in a table. Each column has a name and a data type that defines the kind of data it can hold (e.g., text, numeric, date, etc.). A primary key is a unique identifier for each record in a table. It ensures that each row in the table can be uniquely identified and serves as a reference point for establishing relationships between tables. Likewise, a foreign key is a field or combination of fields in one table that refers to the primary key in another table. It establishes a relationship between the two tables, enabling data integrity and enforcing referential integrity constraints. Constraints define rules or conditions that data in the database must satisfy. Common constraints include primary key constraints, foreign key constraints, unique constraints, and check constraints. Indexes are data structures that improve the speed of data retrieval operations on a database table. They provide quick access to specific rows based on the values of one or more columns and are often created on columns frequently used in search queries. A view is a virtual table derived from one or more tables or other views. It presents a subset of the data stored in the underlying tables and is used to simplify complex queries, enhance security, and provide customized data access. Stored procedures and functions are precompiled and stored in the database for reuse. They contain a set of SQL statements or procedural code that can be executed by applications or other database objects.

SQL databases are often used in financial industries to track and organize data from different sources. For example, lenders use SQL databases in various ways to manage, analyze, and make decisions about loans and borrowers. Lenders may store applicant information in SQL databases to manage the loan origination process. This may include collecting and storing personal, financial, and credit information provided by applicants. Likewise, SQL databases may enable lenders to analyze the creditworthiness of borrowers by accessing and querying credit bureau data, financial histories, and other relevant information stored in the database. In some instances, lenders use SQL queries to assess factors such as credit scores, payment history, debt-to-income ratios, and previous loan performance to evaluate the risk associated with lending to a particular borrower. Lenders may also use SQL databases to facilitate loan underwriting processes by automating decision-making algorithms based on predefined criteria. SQL queries can be used to retrieve and analyze applicant data, calculate risk scores, determine loan eligibility, and set terms and conditions for approved loans.

In some cases, lenders use SQL databases to track loan balances, payment schedules, interest rates, and other details related to active loans. They may generate statements, manage escrow accounts, process payments, and handle borrower communications efficiently using SQL database systems. In addition, lenders are often subject to strict compliance and data reporting requirements. SQL databases may be used to store audit trails, transaction logs, and other compliance-related data to ensure transparency and accountability in lending operations. SQL queries can be used to generate regulatory reports, monitor compliance metrics, and respond to regulatory inquiries or audits.

It can be challenging for lenders to manage the variety of data sources that are fed into their SQL databases. For example, lenders may pull or otherwise receive input databases having their own unique schemas. Such schemas may be configured based on the preferences of the data provider (e.g., customer, loan origination system, etc.). However, these unique schemas are often incompatible with the lender's own schemas. As such, lenders are tasked with reorganizing the input databases to fit their own database schema. This data reorganization process is a tedious, manual process that is prone to introduce errors. In addition, given the high frequency of information requests from investors and regulators, this process has become a constant and expensive task for lenders. As such, an improved system for automatically converting unique input data schemas into target data schemas is provided herein.

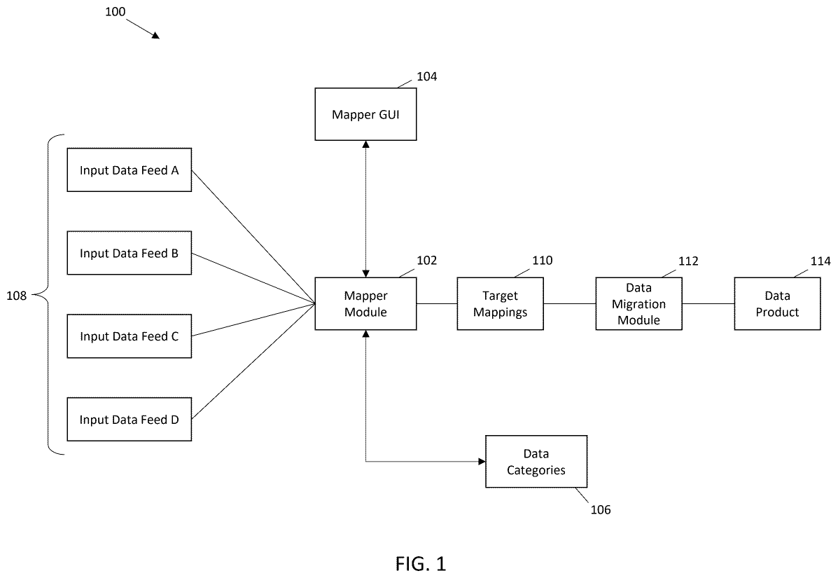

FIG. 1 illustrates a block diagram of a smart mapper system 100 in accordance with aspects described herein. The smart mapper system 100 includes a mapper module 102, a mapper graphical user interface (GUI) 104, a data category library 106, and a data migration module 112. In some examples, the mapper module 102 is configured to utilize one or more mapping algorithms. In some examples, the mapper module 102 is configured to receive a plurality of input data frames or feeds (or databases) 108. Each input data frame 108 may have a different input schema (e.g., Schema A, B, C, D, etc.). In some examples, each input data frame has multiple schemas.

In some examples, the mapper module 102 includes, or is configured to interface with, an artificial intelligence (AI). In some examples, the AI model is a generative pretrained transformer (GPT) model. In some examples, the AI model is a large language model (LLM). The AI model may include model types, such as, for example: a gradient boosted random forest, a regression, a neural network, a decision tree, a support vector machine, a Bayesian network, or other suitable types of models. In some examples, the AI model is a generalized or foundation model. In some examples, the AI model 404 is specifically trained for a specialized application or use-case.

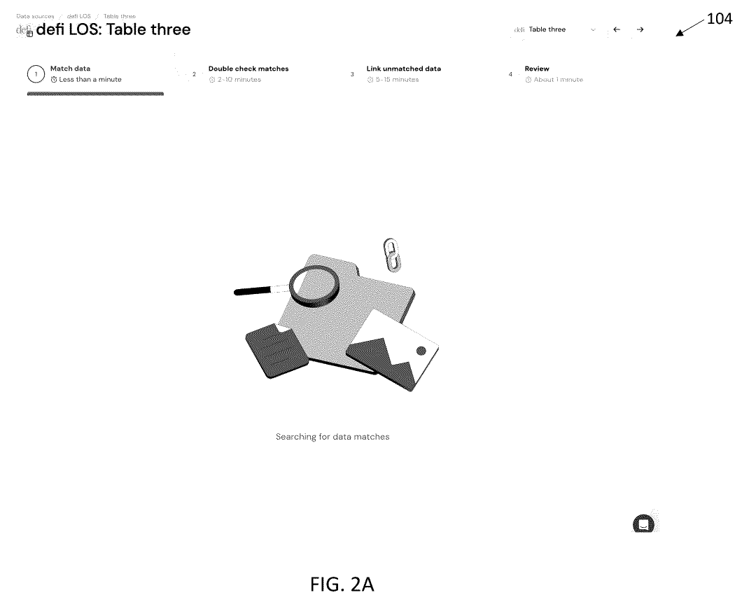

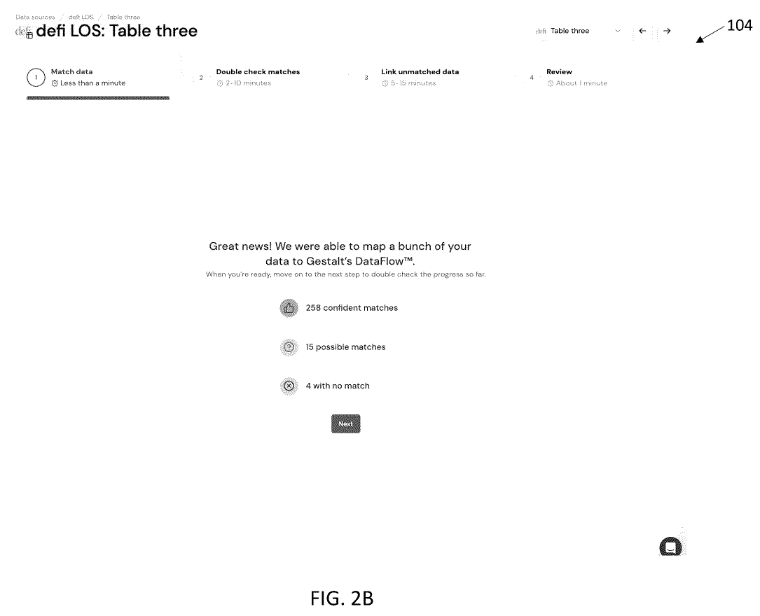

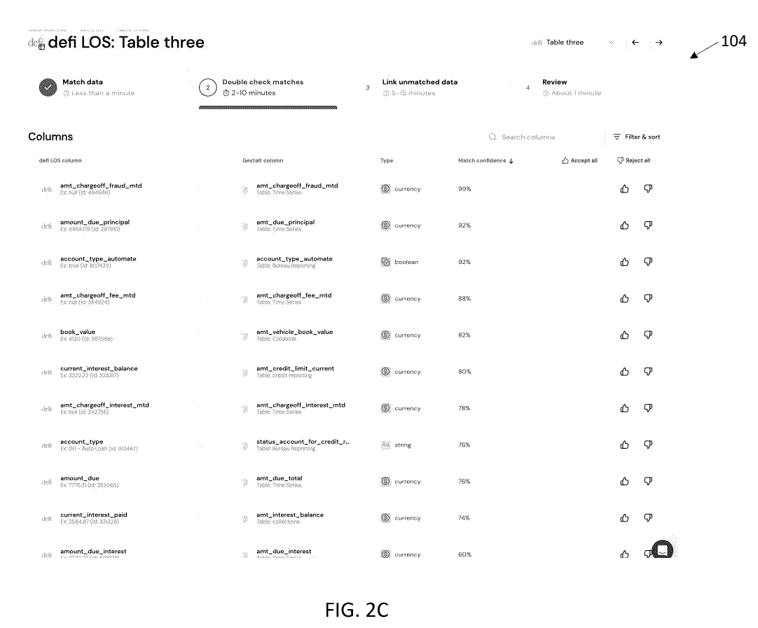

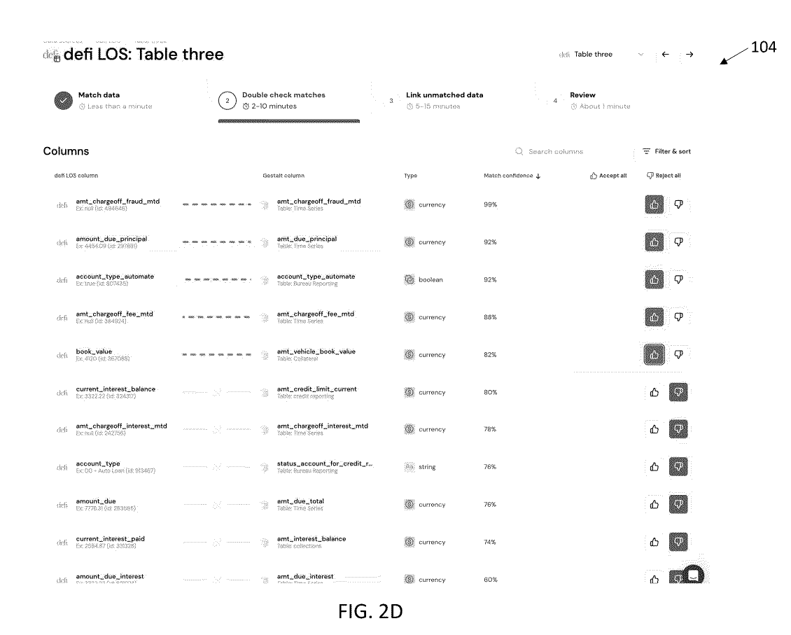

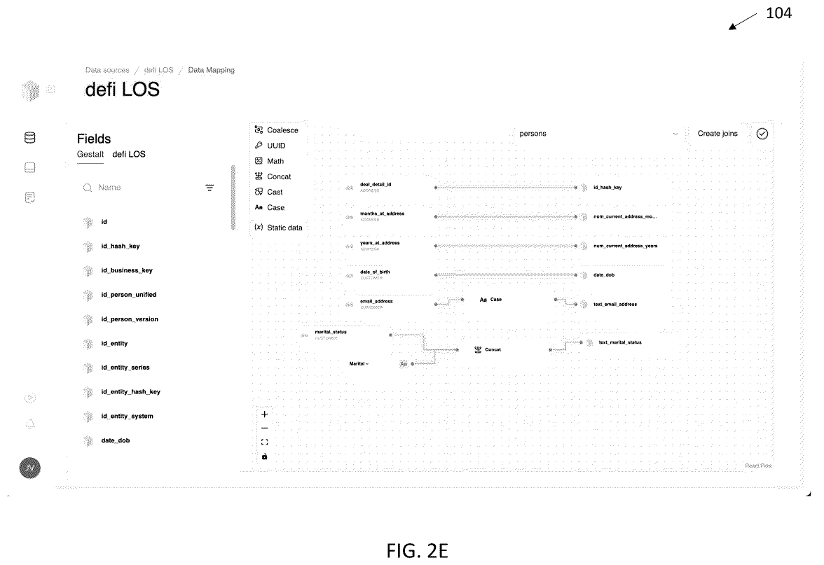

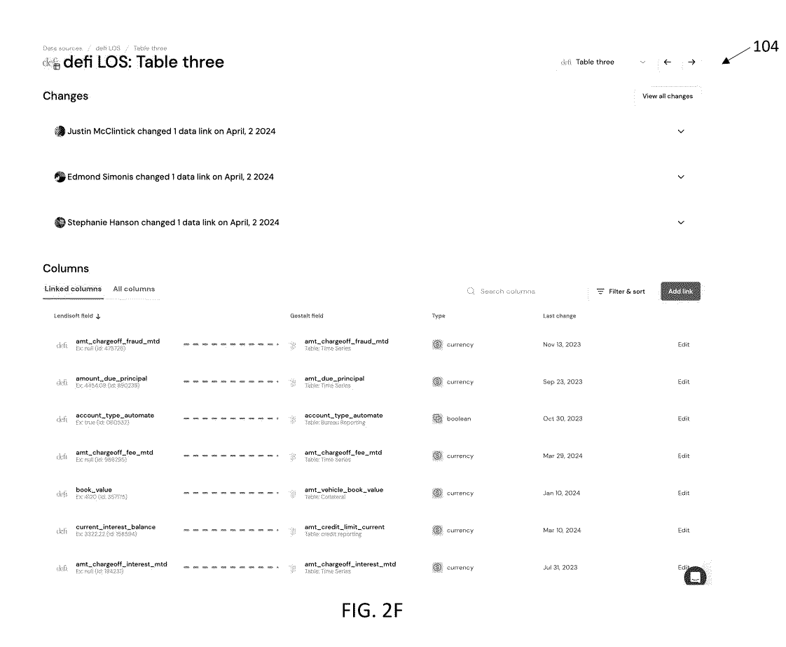

In some examples, a user assigns one or more data categories to each data field of the input data frames 108. For example, the user may utilize the mapper GUI 104 to assign data categories from the data category library 106. In some examples, the mapper module 102 is configured to automatically match data categories from the data category library 106 to the data fields of the input data frames 108. In some examples, a source data model is mapped to a target data model before the mapper module 102 attempts to assign data categories to data fields. FIG. 2A illustrates an example view of the mapper GUI 104 that is presented to users while the mapper module 102 searches for data category matches. As shown in FIG. 2B, the mapper GUI 104 may report the number of data fields that were matched to data categories from the data category library 106. In some examples, the mapper module 102 assigns a confidence level to each data match. For example, in FIG. 2B, 258 data fields had confident matches, 15 data fields had possible matches, and 4 data fields had no match. In some examples, the mapper GUI 104 presents the data matches to the user for review (see FIG. 2C). The mapper GUI 104 may present the input data column (or field), the assigned data category, the identified data type (e.g., currency, Boolean, string, etc.), and the match confidence level or percentage. As shown in FIG. 2D, the user may review the data matches and accept or reject each match. For rejected or unmatched data fields, the user may utilize the mapper GUI 104 to manually assign data categories and mappings. Using the mapper GUI 104 canvas, the user can create mappings (or transformations) on existing data matches or unmatched data fields (see FIGS. 2E and 2F). Any edits or changes are reflected in the mapper GUI 104.

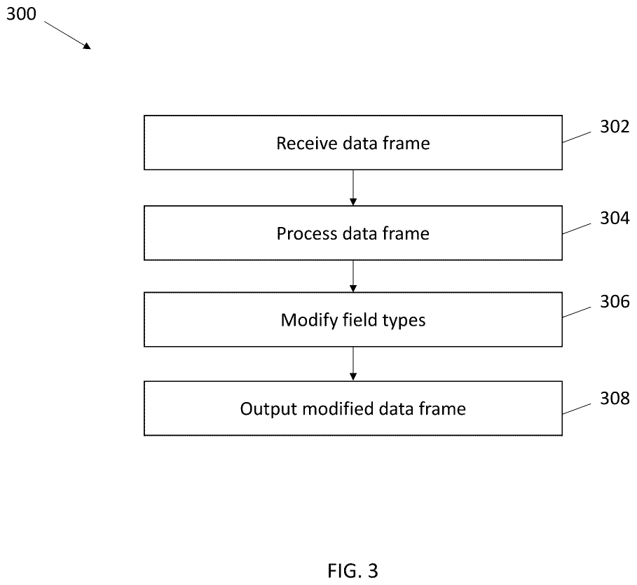

FIG. 3 is a flow diagram of a method 300 for dynamically identifying and categorizing data field types within a data frame (or feed) in accordance with aspects described herein. In some examples, the method 300 is configured to be performed by the smart mapper system 100 (or the mapper module 102) of FIG. 1. In some examples, the method 300 corresponds to at least a portion of the automatic assignment of data categories to data fields described above.

At block 302, the mapper module 102 receives input data frames (e.g., input data frames 108). As discussed above, the input data frames may have unique schemas. In some examples, the schema is associated with at least one financial institution. Each data frame may have unique data fields with associated names and data types.

At block 304, the mapper module 102 processes the data frames to identify data field types. In some examples, the mapper module 102 applies a series of patterns to the field names and data types to identify the data field types. In some examples, the patterns are applied using regular expressions for efficient identification and modification of the field types. In some examples, additional patterns and mappings are used to handle specific field types based on user requirements and/or domain-specific considerations. The data frame may be processed iteratively to ensure accurate identification and mapping of field types.

At block 306, the mapper module 102 modifies the identified field types based on the identified patterns. In some examples, modifying the field types includes removing specific patterns from field names, mapping variations of data types, mapping specific field names to textual or numerical content, and mapping specific patterns. For example, modifying the field types may include: removing specific patterns such as ‘_id’ from field names, mapping variations of varchar to ‘text’, mapping variations of decimal to ‘number’, mapping variations of time to ‘timestamp_ntz’, mapping variations of binary to ‘boolean’, mapping specific field names related to textual content, status, detail to ‘text’, mapping specific field names related to numerical content such as total, statement, transaction, etc., to ‘number’, mapping variations of score to ‘score’, mapping specific field names related to currency to ‘currency’, mapping specific patterns such as ‘_dti’, ‘_ltv’, ‘_pti’ to ‘ratio’, mapping specific field names related to marketing or communication to ‘marketing’, mapping specific field names related to credit reporting agencies or bureaus to ‘bureau’, mapping specific field names related to discounts to ‘discount’, mapping specific field names containing ‘flag’ to ‘boolean’, mapping specific field names containing ‘rate’ to ‘rate’, mapping specific field names containing ‘tax’ to ‘tax’, mapping specific field names containing ‘daycount’, ‘days’, ‘day’ to ‘daycount’, mapping field names starting with ‘id_’ or containing ‘_id’ or ‘id’ to ‘id’, mapping specific field names related to dates to ‘date’, and mapping specific field names related to personally identifiable information (PII) such as name, address, social security, etc., to ‘PII’.

At block 308, the mapper module 102 outputs the modified data frame with the updated field types. In some examples, the mapper module 102 displays the modified data frame via the mapper GUI 104. In some examples, the modified data frame facilitates data analysis, transformation, and management tasks within various computational environments.

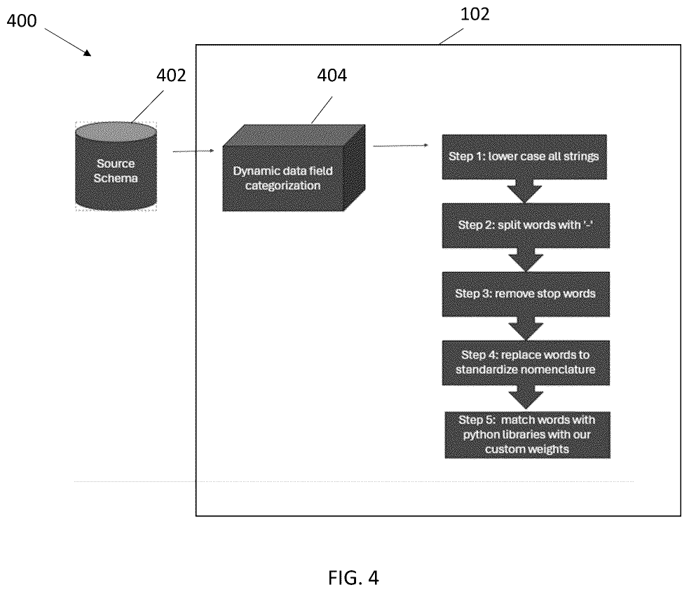

FIG. 4 is a flow diagram of a method 400 for converting a source schema into a target schema in accordance with aspects description herein. In some examples, the method 400 is configured to be performed by the smart mapper system 100 (or the mapper module 102) of FIG. 1. As shown, a data frame (or feed) 402 having a source schema is received by the mapper module 102. In some examples, the source schema of the data frame 402 corresponds to the schema of the input data frame 108. The data frame 402 passes through a dynamic data field categorization process 404. The process 404 may output a modified data frame that is used to convert the source schema to the target schema. In some examples, the process 400 corresponds to the method 300 of FIG. 3.

At step 1, the mapper module 102 converts the text of the source schema to lowercase. In some examples, the text of the source schema is converted to lowercase to ensure standardization and compatibility with the target schema.

At step 2, the mapper module 102 splits joined words to ensure standardization with the target schema. For example, the mapper module may split words with the character ‘_’. In some examples, camel cased words (e.g., “HelloThere” or “hellothere”) are split by the mapper module 102. In some examples, the mapper module 102 includes or is configured to access a dictionary (e.g., via the Python library Spacy). The mapper module 102 may use the dictionary to check if fused words should be split. For example, the mapper module 102 may scan text to identify each word included in the dictionary. If a space appears after a word, the module 102 moves on. However, if there is no space, the module 102 adds a splitting character (e.g., ‘_’).

At step 3, the mapper module 102 removes “stop words” from the source schema. In this context, stop words are common words often considered insignificant or irrelevant in text analysis. Examples of stop words include articles (e.g., “the”, “a”, “an”), prepositions (e.g., “in”, “on”, “at”), conjunctions (e.g., “and”, “but”, “or”), and certain pronouns (e.g., “he”, “she”, “it”). In some examples, users can add additional stop words (e.g., “info”, “data”, “of”, “snapshot”, “on’).

At step 4, the mapper module 102 replaces words or phrases in the source schema with defined terms and nomenclature. In some examples, the defined terms and nomenclature come from a defined list that is used by the target schema. As such, replacing words or phrases in the source schema ensures that the source schema is using the same terminology and nomenclature as the target schema. The defined list may be updated over time (e.g., on a periodic interval). In some examples, the defined list is updated with financial terminology (e.g., that is relevant to lending applications).

At step 5, the mapper engine 102 matches the conditioned source schema with the target schema. In some examples, the mapper engine 102 uses one or more Python matching libraries (e.g., Fuzzy Wuzzy and Levenshtein) to perform the matching function. In one example, the mapper engine 102 uses the Fuzzy Wuzzy library to calculate the similarity ratio between two strings, the column name (or field name) from the target schema and the column name (or field name) from source schema. The Fuzzy Wuzzy library function returns a value between 0 and 100, where 100 indicates a perfect match. In addition, the Levenshtein library is used to calculate the Levenshtein distance between the column name (or field name) from the target schema and the column name (or field name) from source schema. In some examples, the scores from both calculations are combined using a weighted average. The weights assigned to each metric determine the relative importance of each metric in the final score. The weighted average is calculated by taking the weighted sum of the individual scores and dividing by the sum of the weights. In one example, the Fuzzy Wuzzy score is assigned a weight of 0.3 and the Levenshtein score is assigned a weight of 0.7. The weights may be tailored based on specific types of input data. While the weighted average includes two different scores, it should be appreciated that additional scores (e.g., from different libraries or metrics) may be used. In some examples, a minimum accuracy threshold must be met before conditioned source schema is converted into the target source schema. In some examples, the threshold is applied on a field-by-field basis, allowing some fields to be converted even if some are not. In some examples, the mapper module 102 may prompt the user to review and/or edit fields that fall below the minimum accuracy threshold.

In order to improve accuracy, the mapper module 102 may apply semantic similarity techniques that focus on the meaning of a word or group of words. In some examples, the mapper module 102 utilizes one or more vectorizers to implement precise distance metrics between vectors, rather than a string edit metric (e.g., Levenshtein). The mapper module 102 re-ranks the vectorized results using Retrieval Augmented Generation (RAG) techniques within an LLM (e.g., the AI model associated with the mapper module 102). In some examples, the mapper module 102 is configured to select the top N vectorizers (e.g., 3 of 5 different vectorizers) or the top M results (e.g., top 15 results). In some examples, the re-ranker function of the mapper module 102 works by taking all the search information and metadata from the results, formatting it with a complex prompt, and asking the LLM to select the correct result(s) and explain why. In some examples, the re-ranker functionality improves data matching by 30% or more.

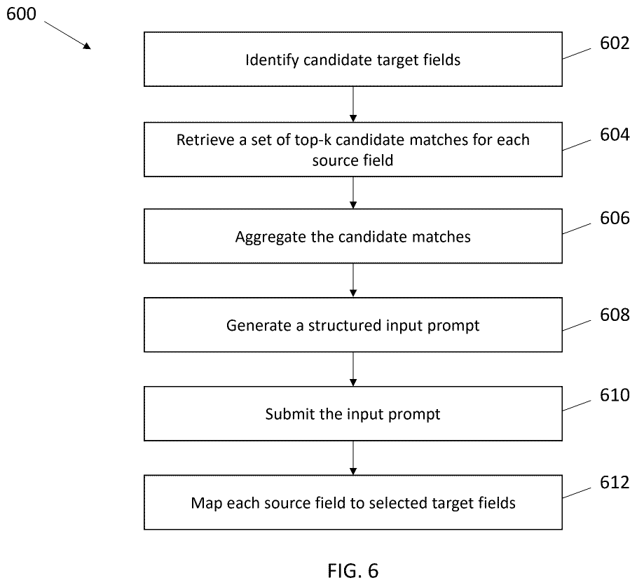

FIG. 6 is a flow diagram of a method 600 for matching a source schema to a target schema in accordance with aspects described herein. In some examples, the method 600 is configured to be performed by the mapper module 102 of the system 100.

At block 602, the mapper module 102 identifies candidate target fields within a target schema (e.g., a canonical lending schema) for each source field using semantic similarity techniques. In some examples, the semantic similarity is determined by encoding the source field metadata and the target field metadata into multiple vector representations using a plurality of vectorizers (or vectorizer encoders).

At block 604, the mapper module 102 retrieves a set of top-k candidate matches for each source field from a vector database. In some examples, the set includes results from multiple vectorizer encoders.

At block 606, the mapper module 102 aggregates the candidate matches into a unified candidate pool.

At block 608, the mapper module 102 generates a structured input prompt that instructs an LLM (e.g., the AI model associated with the mapper module 102) to perform a detailed process for determining the singular best result. In some examples, the LLM is instructed to use input data that includes the original source field information and the metadata of the candidate target fields.

At block 610, the mapper module 102 submits the input prompt (and input data) to the LLM. In some examples, the LLM is configured as a re-ranker that selects a best match among the candidate target fields.

At block 612, the mapper module 102 maps each source field to the selected target field in the target schema based on the LLM's selection.

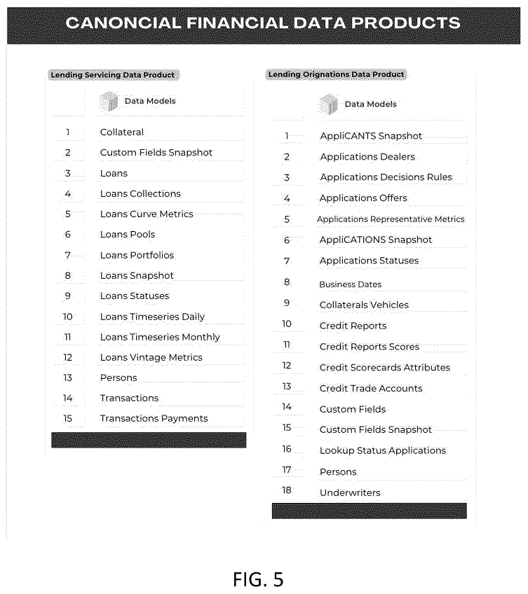

In some examples, the mapper module 102 is configured to output target mappings 110. The target mappings 110 is a proprietary mappings document that stores the necessary information for the data migration module 112 to generate a data product 114. In some examples, the canonical data product has the target schema. In some examples, the data product 114 is a canonical financial data product. FIG. 5 illustrates several examples of canonical financial data products, classified as either a “Lending Servicing Data Product” or a “Lending Originations Data Product.” In some examples, the data migration module 112 uses mappings information (i.e., the target mappings 110) to generate usable SQL data models that provide source-to-target mappings and transformations that can be used to build the user's common data model. In some examples, the data migration tools is an SQL migration tool (e.g., SQLizer).

By automatically converting varying lender source data feeds into the data product 114, the smart mapper system 100 reduces the lender overhead needed to reorganize input data feeds into common schemas. As such, the total time and costs committed to data organization can be reduced, while improving the lender's ability to meet information requests from investors and regulators.

### Anomaly Detection

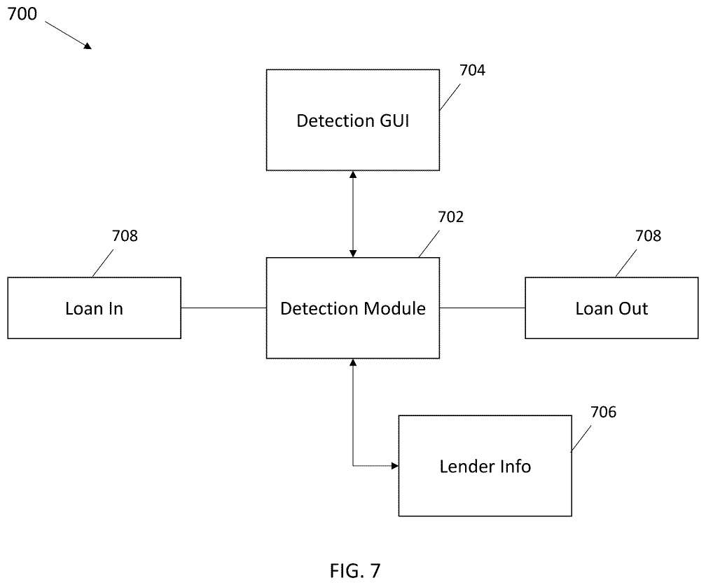

FIG. 7 illustrates an anomaly detection system 700 in accordance with aspects described herein. The anomaly detection system 700 includes a detection module 702, a detection GUI 704, and a lender information database 706. In some examples, the detection module 702 is configured to utilize one or more algorithms. In one example, the detection module uses an algorithm to scan through a lender's loans and find anomalies based on the types of loans that lender has historically been approving or considering. In some examples, the lender's prior approved and denied loans are stored in the lender information database 706. The detection algorithm is specifically configured to process loans in a manner that is fast, accurate, memory optimized and reliable.

In some examples, the detection module 702 generates a machine learning (ML) algorithm that is specific to each lender. For example, the detection module 702 may generate an ML algorithm that is trained based on the lender's prior approved and denied loans (and other lender information). In some examples, the current loans being considered by the lender are used to train the ML algorithm. Once trained, new loans (e.g., loan 708) are fed through the ML algorithm to detect anomalies that are inconsistent with the lender's typical preferences, standards, or business strategies. The loan 708 may be flagged as an anomaly if it is not similar to other loans associated with the lender.

In some examples, the detection module 702 is configured to perform preprocessing for high cardinality. The detection module 702 scans through every column of the loan data and then looks at the cardinality ratio of the column. The cardinality ratio corresponds to the number of unique values compared to row count/loan count in the loan data table. The detection module 702 may be configured to check metadata, schema, and cardinality ratios. In some examples, the detection module 702 removes lender ID's that include primary keys and foreign keys to improve processing speed. For example, if a column name has word ‘ID’ in it or there is a high cardinality ratio along with schema and metadata indicating that it's a primary/foreign key, then the column is deleted and not used for anomaly detection. In some examples, the detection module 702 is configured to perform preprocessing for null and date columns. The detection module 702 deletes any columns that exceed a null threshold limit (e.g., 98% null, 90% null, etc.). In some examples, the detection module 702 scans through every column of the loan data to find dates (e.g., YYYY-MM-DD, MM/DD/YYYY, etc.). Once identified, each date is converted to an integer by subtracting the listed date from the present date. The result is an integer that represents the number of days between the listed date and the present date. Converting various date formats to a common integer format improves the speed and accuracy of the anomaly detection process. In some examples, the preprocessing functions are implemented using Snowpark from Snowflake. The preprocessing functions may be partitioned across many nodes in order to improve processing speed without compromising accuracy.

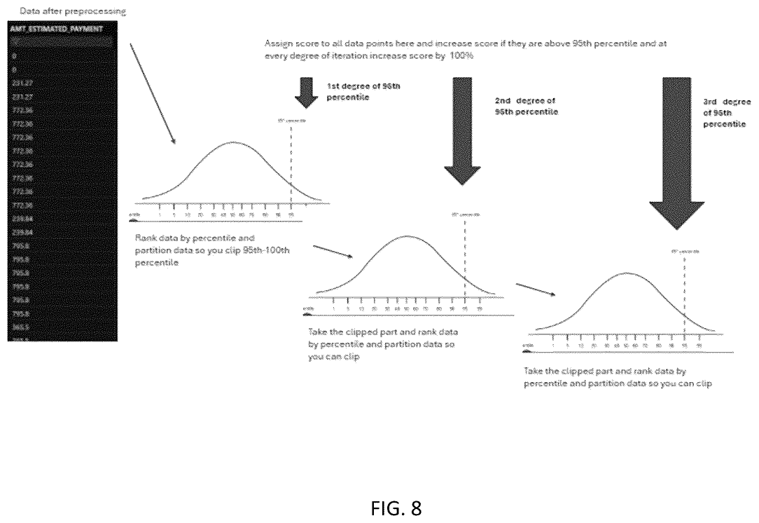

In some examples, the anomaly detection algorithm is based on a decision tree structure. The algorithm starts by randomly selecting a feature/column from the loan data table. The algorithm sorts the feature/column from 1st percentile to 100th percentile and starts to recursively split the column in two parts. In one example, the first part is from 0-95 percentile and other part is from 95th to 100th percentile. The algorithm continues partitioning the column and records how many splits were taken to completely isolate every data point in the column (sec FIG. 8). Anomalies are classified as data points that are isolated with higher partitions, meaning they require higher splits to be isolated. Once the decision tree structure is built, a score is assigned to each data point based on the average path length required to isolate it. This process is repeated for every column and every data point in the column.

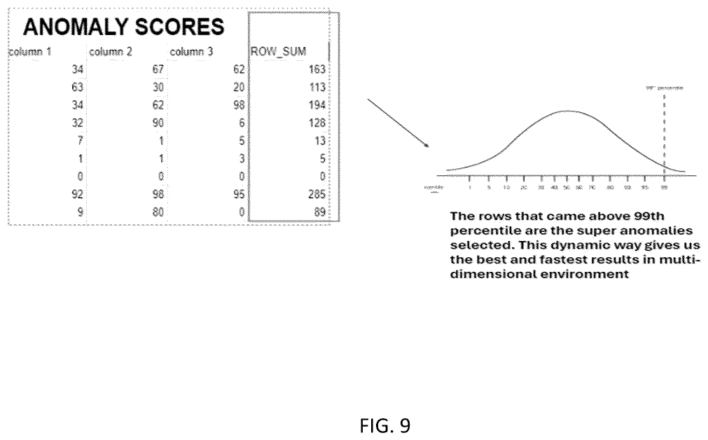

The assigned scores are then aggregated at row level, providing an aggregated anomaly score for every row. In some examples, a dynamic threshold is used to identify row anomalies. The aggregate row scores are placed on a bell curve to determine which rows are anomalies (see FIG. 9). In some examples, a row score above the 99^{th} percentile may be considered an anomaly. It should be appreciated that the threshold may be adjusted based on the lender's preferences. For example, higher thresholds allow lender's to screen for “super-anomalies”. Many lenders deal with a large number of loans (e.g., over 400 k) and are interested in identifying the most significant anomalies (e.g., the top 50 or the top 0.0125%).

In addition to identifying rows with anomalies, the detection module 702 may be configured to identify the features (e.g., top 5) that caused each row to be an anomaly. In some examples, the detection module 702 can provide the user with the percentile in the original data (i.e., prior to preprocessing). The detection module 702 is configured to flag the top scores in each row as the data points that caused the row anomaly. In some examples, the detection module 702 finds the percentile rank of each flagged data point in its respective column. In some examples, the detection module 702 calculates the median for each relevant column and provides a metric indicating how much larger or smaller the flagged data point was relative to the median. These metrics can be presented to the user (e.g., via the detection GUI 704) such that the user has an understanding of a normal value with respect to the data values in question.

### Hardware and Software Implementations

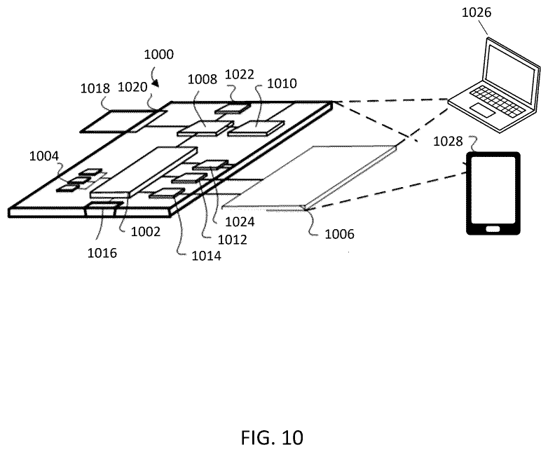

FIG. 10 shows an example of a generic computing device 1000, which may be used with some of the techniques described in this disclosure. Computing device 1000 includes a processor 1002, memory 1004, an input/output device such as a display 1006, a communication interface 1008, and a transceiver 1010, among other components. The device 1000 may also be provided with a storage device, such as a micro-drive or other device, to provide additional storage. Each of the components 1000, 1002, 1004, 1006, 1008, and 1010, are interconnected using various buses, and several of the components may be mounted on a common motherboard or in other manners as appropriate.

The processor 1002 can execute instructions within the computing device 1000, including instructions stored in the memory 1004. The processor 1002 may be implemented as a chipset of chips that include separate and multiple analog and digital processors. The processor 1002 may provide, for example, for coordination of the other components of the device 1000, such as control of user interfaces, applications run by device 1000, and wireless communication by device 1000.

Processor 1002 may communicate with a user through control interface 1012 and display interface 1014 coupled to a display 1006. The display 1006 may be, for example, a TFT LCD (Thin-Film-Transistor Liquid Crystal Display) or an OLED (Organic Light Emitting Diode) display, or other appropriate display technology. The display interface 1014 may comprise appropriate circuitry for driving the display 1006 to present graphical and other information to a user. The control interface 1012 may receive commands from a user and convert them for submission to the processor 1002. In addition, an external interface 1016 may be provided in communication with processor 1002, so as to enable near area communication of device 1000 with other devices. External interface 1016 may provide, for example, for wired communication in some implementations, or for wireless communication in other implementations, and multiple interfaces may also be used.

The memory 1004 stores information within the computing device 1000. The memory 1004 can be implemented as one or more of a computer-readable medium or media, a volatile memory unit or units, or a non-volatile memory unit or units. Expansion memory 1018 may also be provided and connected to device 1000 through expansion interface 1020, which may include, for example, a SIMM (Single In Line Memory Module) card interface. Such expansion memory 1018 may provide extra storage space for device 1000, or may also store applications or other information for device 1000. Specifically, expansion memory 1018 may include instructions to carry out or supplement the processes described above, and may include secure information also. Thus, for example, expansion memory 1018 may be provided as a security module for device 1000, and may be programmed with instructions that permit secure use of device 1000. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1004, expansion memory 1018, memory on processor 1002, or a propagated signal that may be received, for example, over transceiver 1010 or external interface 1016.

Device 1000 may communicate wirelessly through communication interface 1008, which may include digital signal processing circuitry where necessary. Communication interface 1008 may in some cases be a cellular modem. Communication interface 1008 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1010. In addition, short-range communication may occur, such as using a Bluetooth, WiFi, or other such transceiver (not shown). In addition, GPS (Global Positioning System) receiver module 1022 may provide additional navigation- and location-related wireless data to device 1000, which may be used as appropriate by applications running on device 1000.

Device 1000 may also communicate audibly using audio codec 1024, which may receive spoken information from a user and convert it to usable digital information. Audio codec 1024 may likewise generate audible sound for a user, such as through a speaker, e.g., in a handset of device 1000. Such sound may include sound from voice telephone calls, may include recorded sound (e.g., voice messages, music files, etc.) and may also include sound generated by applications operating on device 1000. In some examples, the device 1000 includes a microphone to collect audio (e.g., speech) from a user. Likewise, the device 1000 may include an input to receive a connection from an external microphone.

The computing device 1000 may be implemented in a number of different forms, as shown in FIG. 10. For example, it may be implemented as a computer (e.g., laptop) 1026. It may also be implemented as part of a smartphone 1028, smart watch, tablet, personal digital assistant, or other similar mobile device.

Some implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system for converting a source data feed into a canonical data product, comprising:
at least one memory for storing computer-executable instructions; and
at least one processor for executing the instructions stored on the at least one memory, wherein execution of the instructions programs the at least one processor to perform operations comprising:
receiving a source data feed having a source schema;
identifying a plurality of data fields of the source schema;
assigning a data category from a plurality of predefined data categories to each data field of the plurality of data fields;
modifying the source schema based on predefined parameters, wherein the source schema is modified to match a target schema;
comparing the modified source schema to the target schema; and
in response to a determination that the modified source schema matches the target schema, converting the source data feed to a canonical data product having the target schema based on the assigned data categories.

2. The system of claim 1, wherein the source schema is associated with at least one financial institution.

3. The system of claim 1, wherein the canonical data product is a financial canonical data product.

4. The system of claim 1, wherein execution of the instructions programs the at least one processor to perform operations further comprising:
determining, for each data field of the plurality of data fields, a confidence level associated with the assigned data category.

5. The system of claim 4, wherein the confidence level is represented as a percentage.

6. The system of claim 1, wherein identifying the plurality of data fields of the source schema includes identifying a data type of each data field of the plurality of data fields.

7. The system of claim 6, wherein execution of the instructions programs the at least one processor to perform operations further comprising:
applying a plurality of data patterns to each data field of the plurality of data fields to identify the data type.

8. The system of claim 7, wherein each data pattern of the plurality of data patterns corresponds to at least one regular expression.

9. The system of claim 1, wherein modifying the source schema based on predefined parameters includes modifying a name of a data field, modifying a data type of a data field, consolidating multiple data fields, or any combination thereof.

10. The system of claim 9, wherein modifying the name of the data field includes replacing at least one term in the name with at least one term from a predefined list of terms.

11. The system of claim 1, wherein execution of the instructions programs the at least one processor to perform operations further comprising:
evaluating, via a matching function, a match level between the modified source schema and the target schema.

12. The system of claim 11, wherein execution of the instructions programs the at least one processor to perform operations further comprising:
comparing the match level to a minimum accuracy threshold; and
in response to a determination that the match level meets or exceeds the minimum accuracy threshold, converting the source data feed to the canonical data product.

13. A method for converting a source data feed into a canonical data product, comprising:
receiving a source data feed having a source schema;
identifying a plurality of data fields of the source schema;
assigning a data category from a plurality of predefined data categories to each data field of the plurality of data fields;
modifying the source schema based on predefined parameters, wherein the source schema is modified to match a target database schema;
comparing the modified source schema to the target schema; and
in response to a determination that the modified source schema matches the target schema, converting the source data feed to a canonical data product having the target schema based on the assigned data categories.

14. The system of claim 13, wherein the source schema is associated with at least one financial institution.

15. The system of claim 13, wherein the canonical data product is a financial canonical data product.

16. The method of claim 13, further comprising:
determining, for each data field of the plurality of data fields, a confidence level associated with the assigned data category.

17. The method of claim 16, wherein the confidence level is represented as a percentage.

18. The method of claim 13, wherein identifying the plurality of data fields of the source schema includes identifying a data type of each data field of the plurality of data fields.

19. The method of claim 18, further comprising:
applying a plurality of data patterns to each data field of the plurality of data fields to identify the data type.

20. The method of claim 19, wherein each data pattern of the plurality of data patterns corresponds to at least one regular expression.

21. The method of claim 13, wherein modifying the source schema based on predefined parameters includes modifying a name of a data field, modifying a data type of a data field, consolidating multiple data fields, or any combination thereof.

22. The method of claim 21, wherein modifying the name of the data field includes replacing at least one term in the name with at least one term from a predefined list of terms.

23. The method of claim 13, further comprising:
evaluating, via a matching function, a match level between the modified source schema and the target schema.

24. The method of claim 23, further comprising:
comparing the match level to a minimum accuracy threshold; and
in response to a determination that the match level meets or exceeds the minimum accuracy threshold, converting the source data feed to the canonical data product.
